(19) United States
(12) Patent Application Publication
(10) Pub. No.: US 2022/0072627 A1
(43) Pub. Date: Mar. 10, 2022

(54) TOOL HOLDER AND TOOL SYSTEM

(71) Applicants: Hartmetall-Werkzeugfabrik Paul Horn GmbH, Tuebingen (DE); Kistler Holding AG, Winterthur (CH)

(72) Inventors: Gunnar KEITZEL, Hettlingen (CH); Tobias KEMMLER, Pliezhausen (DE)

(21) Appl. No.: 17/469,967

(22) Filed: Sep. 9, 2021

(30) Foreign Application Priority Data
Sep. 9, 2020 (EP) 20 195 286.8

(51) Int. Cl. B23B 29/04; B23Q 17/09

(52) U.S. Cl. CPC B23B 29/043; B23B 2260/128; B23Q 17/0966

(57) ABSTRACT

Tool holder comprising a tool receptacle, a machine interface, and a sensor receptacle. The tool receptacle is configured to releasably receive a tool having at least one cutting edge for machining a workpiece. The machine interface is configured to enable the tool holder to be fastened to a machine tool. In the sensor receptacle, a sensor is arranged that is configured to generate a measurement signal that is dependent on a force acting on the tool holder The sensor receptacle is spaced apart from both the tool receptacle and the machine interface, so that the sensor is neither in direct contact with the tool nor in direct contact with the machine tool when the tool is accommodated in the tool receptacle and the tool holder is fastened to the machine tool.

### CROSS REFERENCE TO RELATED APPLICATIONS

This application claims priority from European patent application EP 20 195 286.8 filed on Sep. 9, 2020. The entire content of this priority application is incorporated herein by reference.

### BACKGROUND

This disclosure relates to a tool holder for a tool for machining a workpiece.

Further, the disclosure relates to a tool system comprising a tool holder and a tool having at least one cutting edge for machining the workpiece. The tool may in principle be any type of cutting tool. For example, the tool is a turning tool or a milling tool.

The sensor used in the tool holder may comprise a force transducer.

When manufacturing workpieces by means of machine tools, there is often a desire to measure the forces acting on the tool arranged in the tool holder, which in turn is fastened in the machine tool.

The use of sensors to monitor various forces acting on the tool is already known in principle from the prior art.

EP 1 984 142 B1, for example, discloses using piezoceramic sensors to measure the compressive, tensile and shear forces exerted on the cutting body or the holder of the tool and to control the machine tool in such a way that damage due to overloading is prevented. Therein, threshold values are specified for the forces, wherein it is intervened in the machining process if said threshold values are exceeded.

A similar tool in which one or more sensors are used on the tool for the purpose of preventive breakage, crack and/or wear detection of the cutting insert is disclosed in DE 10 2014 224 778 A1.

However, the use of such sensors in cutting tools and tool holders does not necessarily have to serve the purpose of detecting breakage or wear of a cutting insert that is exchangeably arranged on the tool. The sensors can also be used for quality assurance and/or documentation. For example, such sensors can be used to record the forces acting on the cutting insert of the tool during machining over time and store them for documentation purposes. They are then often used to monitor the process force and the process stability. Likewise, this can serve for tool condition monitoring, which has a positive effect on the robustness and durability of such tool systems in the industrial long-term use.

As far as the type of sensors to be used for this purpose is concerned, dynamometers could basically be used. However, their large dimensions are disadvantageous, so that dynamometers often interfere in the machine room and cannot be installed at any position in a machine tool. In addition, the manufacturing and procurement costs of dynamometers are relatively high.

Strain gauges can also be used to measure tool forces. As a matter of principle, strain gauges require a certain flexibility of the machine parts to be measured, especially of the tools, which, however, is undesirable in the precision machining of workpieces. The use of strain gauges therefore leads to a low dynamic resolution of the measurements.

A multi-component force measurement arrangement is further disclosed in CH 680 421 A5. However, for most applications in machining technology, a force measurement in one characteristic force direction is sufficient and no multidimensional measurement (for example 3-component measurement) is required.

A much more important property is often the stability with regard to the sensitivity of the sensor technology over long periods of time, so that changes in the machining processes can be reliably compared and assessed over a large number of cycles and production orders. However, the desire for the highest possible sensitivity of the measurement is often countered by the problem of arranging the sensor as suitable as possible within the machine tool or within the tool.

To enable a measurement that is as accurate as possible, it is often desirable to use the sensor as close as possible to the processing point, i.e. as close as possible to the cutting edge of the tool. However, this is often problematic not only for space reasons, but also for pure stability reasons. For example, in the case of tools with exchangeable cutting inserts that are clamped in a cutting insert holder, it is only possible to a limited extent to mount a sensor in the cutting insert holder directly between the cutting insert and the cutting insert holder. However, such an attachment is usually rather unsuitable for the tools known from the prior art for purely mechanical reasons, since the sensor could impair the stability of the clamping of the cutting insert in the cutting insert holder.

Mounting the sensor at the connection point at which the tool is clamped in the tool holder, or at the connection point at which the tool holder is fastened to the machine tool, is, both for space reasons and for stability reasons, much easier to ensure. WO 2020/074434 A1, for example, discloses arranging a sensor in a recess on the shank of the tool, so that the sensor is arranged between the shank of the tool and the tool holder in which the tool is clamped.

DE 34 07 619 A1 further discloses arranging the sensor housing directly adjacent to a machine part in a corresponding recess. Furthermore, DE 10 2012 005 555 B3 discloses providing a measuring plate with hollow cylindrical recesses in which piezoelectric sensors for measuring forces of different force directions are each mounted under preload by means of a screwed-on thrust piece. Such a measuring plate is particularly suitable for measuring high shear and compressive forces occurring between bearing surfaces.

Compared to the aforementioned solutions already known from the prior art, it is desirable to determine an arrangement of a sensor within the tool system that enables a reduction of the hysteresis of the sensor and thus more stable and reliably repeatable measurements. Furthermore, the system should not be adversely affected by changing cutting inserts within the tool or by changing the entire tool. Additionally, the tool system should be user-friendly and should not generate significant additional effort when setting up the tool.

### SUMMARY

It is an object to provide a tool holder and a tool system, which fulfill the aforementioned targets as good as possible with respect to linearity, a reduction of the disturbing hysteresis of the sensor, an improvement of the measuring stability and a handling that is as simple as possible.

According to a first aspect, a tool holder is provided, comprising:
a tool receptacle that is configured to releasably receive a tool having at least one cutting edge for machining a workpiece;
a machine interface that is configured to enable the tool holder to be fastened to a machine tool; and
a sensor receptacle in which a sensor is accommodated that is configured to generate a measurement signal that is dependent on a force acting on the tool holder, wherein the sensor receptacle is spaced apart from both the tool receptacle and the machine interface, so that the sensor is neither in direct contact with the tool nor in direct contact with the machine tool when the tool is accommodated in the tool receptacle and the tool holder is fastened to the machine tool.

According to a second aspect, a tool system is provided, comprising:
a tool having at least one cutting edge for machining the workpiece; and
a tool holder;
wherein the tool holder comprises:
   a tool receptacle that is configured to releasably receive the tool;
   a machine interface that is configured to enable the tool holder to be fastened to a machine tool; and
   a sensor receptacle in which a sensor is accommodated that is configured to generate a measurement signal that is dependent on a force acting on the tool holder, wherein the sensor receptacle is spaced apart from both the tool receptacle and the machine interface, so that the sensor is neither in direct contact with the tool nor in direct contact with the machine tool when the tool is accommodated in the tool receptacle and the tool holder is fastened to the machine tool.

At first glance, one might think that the type of arrangement of the sensor is disadvantageous, since the sensor is not arranged within the tool holder directly in frictional contact at the connection point between the tool holder and the machine tool or at the connection point between the tool holder and the tool received therein. In fact, however, the arrangement of the sensor at a distance from the two aforementioned points is advantageous not only in terms of measurement stability and repeatability, but also in terms of various other aspects. By placing it in the force shunt, it is true that the force components flowing through the sensor are smaller than when placing it directly in the frictional connection. However, the inventors have recognized that by the described arrangement of the sensor a high measurement quality, described by the linearity and a hysteresis as small as possible, can be ensured. Interference is reduced, so that the repeatability of the measurement is significantly improved.

The sensor is fully integrated into the holder and thus arranged at a protected position. The mounting in the force flow within the tool holder enables very precise measurements. Furthermore, the integration into the tool holder enables a simple and orderly supply of the cables.

Another particular advantage is the fact that the tool is easily detachable from the tool holder and replaceable by another tool without having to remove the sensor and the associated cable from the tool holder or change their arrangement. Hence, the mounting of a tool on the tool holder has no significant influence or no influence at all on the sensor technology.

In a refinement, a sensitive axis of the sensor, along which the sensor has its main sensitivity, is oriented at an acute angle relative to a longitudinal axis of the tool holder.

If the sensor is configured as a force transducer, said sensitive axis may, for example, be an axis oriented perpendicular to an upper side of the sensor. The longitudinal axis of the tool holder, to which the sensitive axis of the sensor is preferably inclined at an acute angle, is preferably oriented transverse to the at least one cutting edge of the tool.

In the present context, “transverse” is understood to mean any type of orientation that is not parallel. This includes any type of orientation at an angle other than 0°. Hence, the term “transverse” also includes perpendicular or orthogonal, but is not limited thereto.

In a further refinement, the sensitive axis of the sensor coincides with a direction of a resultant force resulting from the force acting on the at least one cutting edge or is oriented at an angle of at most 10° to this direction.

Thus, for most applications the sensitive axis of the sensor matches the largest force direction as well as possible. The insertion angle of the sensor corresponds to the direction of the force resulting from the cutting force. The sensor is thus positioned exactly in the force flow within the tool holder, so that a very precise measurement is possible. Due to the fact that the sensitive axis of the sensor corresponds as well as possible with the resulting force direction in the tension/compression direction, the sensor is subjected to as little shear stress as possible, so that the smallest possible hysteresis occurs during the measurement.

A deviation of 10° from this force direction is generally tolerable. It goes without saying that a deviation of +1-10° is meant here, so that the specification is to be understood as a specification in terms of amount. Preferably, said directional deviation of the sensitive axis relative to the direction of the resultant force is at most 5°. Particularly preferably, the sensitive axis is oriented parallel to the direction of the resulting force or coincides with it.

According to a further refinement, it is preferred that the tool holder comprises, for abutment with the tool, a first abutment surface and a second abutment surface extending transversely thereto, and that the sensitive axis of the sensor is oriented at a first acute angle relative to the first abutment surface and at a second acute angle relative to the second abutment surface.

The tool preferably lies flush against the tool holder at each of the two abutment surfaces mentioned when the tool is held in the tool receptacle of the tool holder. It is to be noted that in principle further abutment surfaces or individual abutment points can be present. Preferably, the sensitive axis of the sensor is oriented at an angle of 30°-60° to the two said abutment surfaces of the tool receptacle of the tool holder. Particularly preferably, the two said abutment surfaces are oriented perpendicularly or orthogonally to each other, so that said two acute angles (first and second acute angle) are then counter angles, both of which preferably fall within the aforementioned angular range.

Depending on the type of application, the previously mentioned angles can also represent a compromise that is intended to cover as many different types of tools as possible.

For example, the first abutment surface can be oriented parallel to the longitudinal axis of the tool holder. In this case, the aforementioned first acute angle corresponds to the aforementioned insertion angle of the sensor that is measured between the sensitive axis of the sensor and the longitudinal axis of the tool holder. For a combined tension and compression load, the insertion angle of the sensor is selected in the previously mentioned range of 30°-60°. For a pure shear load, on the other hand, the insertion angle of the sensor would be selected as 0°.

In a further refinement, the sensor mounted in the sensor receptacle is arranged in the force shunt of the tool holder. Thereby, a large part of the force continues to flow through the tool holder, so that the stability of the tool holder and thus the stability of the entire tool system is only minimally reduced.

According to a further refinement, it is provided that the sensor receptacle is configured as a receptacle pocket which encloses the sensor from at least four sides. Particularly preferably, the sensor receptacle configured as a receiving pocket encloses the sensor from five sides.

According to this refinement, the sensor is thus surrounded as if by a closed frame. This keeps the notch effect on the tool holder as low as possible compared to an open frame, avoids permanent deformation of the tool holder and ensures robustness for larger forces to be measured. If the sensor is enclosed not only from four but from five sides, the robustness and stability are further increased.

According to a further refinement, it is provided that the sensor is clamped in the sensor receptacle by means of a clamping device.

By means of this clamping device, the sensor is preloaded even when the tool holder is not under force. This is important so that the sensor can measure both tensile and compressive loads along its sensitive axis. In case of a pure measurement of tensile load, the preload of the sensor is preferably selected to be larger than the tensile force acting on the sensor inserted in the tool holder as a result of the machining process. This is necessary so that the sensor always remains in a preloaded state.

The clamping device is preferably configured to be at least partially detachable from the tool holder. Particularly preferably, the clamping device can be completely detached from the tool holder.

According to a further refinement, it is provided that the clamping device comprises a first wedge element and a second wedge element. By means of these two wedge elements, the sensor can be clamped very easily in the sensor receptacle of the tool holder. In addition to the simple clamping, the advantage consists essentially in the releasability and the positionability of the sensor.

Preferably, the first wedge element with a first side surface abuts the sensor and with an opposite second side surface abuts a wedge surface of the second wedge element, wherein the second side surface of the first wedge element and the wedge surface of the second wedge element are oriented at an acute angle relative to the first side surface. This latter acute angle is the same for both the second side surface and the wedge surface.

Hence, according to this refinement, there are two opposed wedge elements that are clamped in the pocket-shaped sensor receptacle in order to fasten the sensor. This further reduces the shear forces.

It goes without saying that the term “wedge surface” of the second wedge element was used merely to distinguish the “side surfaces” of the first wedge element, but is not to be understood in a restrictive manner in the present case. This “wedge surface” is also a side surface of the second wedge element.

One of the two wedge elements, preferably the second wedge element, is preferably displaceably fastened in the sensor receptacle by means of a fastening element. The fastening element is, for example, a screw, by means of which the second wedge element can be displaced within the sensor receptacle. This type of combined screw/wedge connection allows the preload force of the sensor to be adjusted very precisely. This in turn has a positive effect on reducing the hysteresis and thus on the measurement stability of the sensor.

According to a refinement, it is provided that a support is arranged in the sensor receptacle, support is configured to support the first wedge element when the second wedge element is pushed into the sensor receptacle.

Due to this support, the first wedge element facing the sensor does not exert any shear forces on the sensor when the second wedge element is inserted, which shear forces could negatively influence or even damage the sensor. The support can be, for example, a support surface provided in the sensor receptacle, against which the first wedge element lies flush.

According to a further refinement, it is provided that a sensitive axis of the sensor, along which the sensor has its main sensitivity, is oriented parallel to a longitudinal axis of the tool holder. This is particularly desirable when the direction of the resultant force at the location of the sensor is oriented parallel to the longitudinal axis of the tool holder.

For example, this can be advantageous in a refinement of the tool holder in which the tool receptacle is arranged at a front end of the tool holder and is configured as a pot-shaped recess in the tool holder.

As already mentioned, the sensor is preferably a force transducer. This force transducer can, for example, comprise a piezoelectric sensor. Such a piezoelectric sensor can be modified electronically in the measuring range and its measurement results are not dependent on deformation of the tool holder. Piezo sensors are also subject to a very low aging process, so that stable and repeatable measurements are possible with the sensor over a very long service life.

According to a further refinement, the sensor comprises a cable that is routed out of the sensor receptacle through a cable duct extending inside the tool holder.

In other words, the cable is guided inside the tool holder according to this refinement. The cable duct preferably comprises a cable outlet which is arranged on the side of the tool holder facing away from the tool and at which the cable leaves the cable duct. The exit of the cable is thus preferably selected on the side of the tool holder facing away from the cutting edge of the tool. In this way, the cable is safely accommodated and protected from damage, especially during a tool change.

As mentioned at the outset, the present disclosure relates not only to the tool holder itself, but also to a tool system comprising the tool holder and the tool that can be clamped therein having the at least one cutting edge for machining the workpiece.

In a refinement of this tool system, it is provided that the tool is a tool cartridge having a cutting insert receptacle in which a cutting insert is arranged on which the at least one cutting edge is formed, and that the tool cartridge is detachably fastened to the tool holder in the tool receptacle by means of at least one fastening element.

Due to their relatively space-saving design, such tool cartridges are particularly suitable for use in machine tools in which several tools are to be used simultaneously. The tool itself can be a turning tool or a milling tool, for example. The tool cartridge typically has a relatively flat design and is detachably fastened to the tool holder by one or more fastening screws, which serve as fastening elements. If required, the tool cartridge can thus be easily and quickly detached from the tool holder. If only the cutting insert needs to be replaced, for example due to wear, the tool cartridge, on the other hand, can remain mounted on the tool holder and the cutting insert can be detached separately from the tool cartridge and replaced by a new one.

It goes without saying that the features mentioned above and those yet to be explained below can be used not only in the respectively provided combination, but also in other combinations or standing alone, without leaving the spirit and scope of the present disclosure. Likewise, it goes without saying that the features defined in the claims relating to the tool holder refer not only to the tool holder, but also in an equivalent manner to the tool system. Therefore, all of the preceding statements refer not only to the tool holder, but equivalently also to the tool system, which includes the tool holder.

### BRIEF DESCRIPTION OF THE DRAWINGS

FIG. 1 shows a perspective view of a first embodiment of the tool system, comprising the tool holder;

FIG. 2 shows an exploded view of the first embodiment of the tool system shown in FIG. 1;

FIG. 3 shows a side view of the first embodiment of the tool system shown in FIG. 1;

FIG. 4 shows another side view of the first embodiment of the tool system shown in FIG. 1;

FIG. 5 shows a sectional view of a detail of the first embodiment of the tool holder shown in FIG. 1;

FIG. 6 shows a perspective view of a second embodiment of the tool system according to the invention, comprising the tool holder;

FIG. 7 shows an exploded view of the second embodiment of the tool system shown in FIG. 6; and

FIG. 8 shows a sectional view of the second embodiment of the tool system shown in FIG. 6.

### DESCRIPTION OF PREFERRED EMBODIMENTS

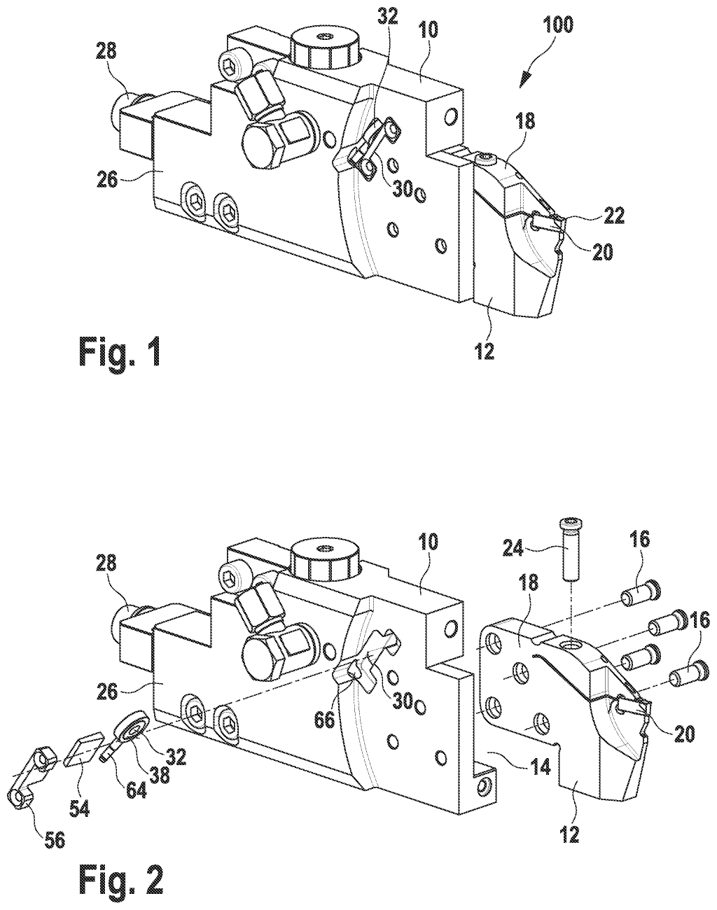

FIGS. 1-4 show a first embodiment of the tool system in a perspective view, an exploded view and two side views. The tool system is denoted therein in its entirety with the reference numeral 100.

The tool system 100 comprises a tool holder 10 and a tool 12. The tool 12 is detachably fastened to the tool holder 10. For this purpose, the tool holder 10 comprises a pocket-shaped tool receptacle 14 in which the tool 12 can be arranged in a precisely defined manner. In the present embodiment, four screws 16 serve to fasten the tool 12 in the tool receptacle 14. However, it goes without saying that more or fewer screws may also be used to fasten the tool 12 to the tool holder 10. Likewise, other fastening means for fastening the tool 12 to the tool holder 10 are conceivable.

The tool 12 itself comprises a cutting insert holder 18 and a cutting insert 20 detachably arranged therein. The cutting insert 20 is typically a cutting insert or a socalled indexable insert made of carbide. The cutting insert 20 comprises at least one cutting edge 22 for machining a workpiece. In this case, it is a cutting edge 22 with a straight cutting edge. However, the cutting insert 20 can just as well comprise a curved cutting edge or several different cutting edges for machining the workpiece.

In the herein shown embodiment, the tool 12 is configured as a turning tool which is particularly suitable for groove turning. However, the present disclosure is not limited to this type of configuration of the tool 12.

The cutting insert holder 18 is configured as a tool cartridge, which is particularly advantageous for space reasons if several such tool systems are used simultaneously within a machine tool. The fixation of the cutting insert 20 in the cutting insert holder or the tool cartridge 18 is carried out here by means of a further clamping screw 24. However, other fixing means for clamping the cutting insert 20 are also conceivable. In any case, it is advantageous if the cutting insert 20 can be released separately from the tool cartridge 18 without the latter in turn having to be released from the tool holder 10. In this way, the cutting insert 20 can be replaced very easily by a new one when it is worn out, without having to remove the entire tool 12 from the tool holder 10 for this purpose.

The tool holder 10 further comprises a machine interface 26 that allows the tool holder 10 to be fastened to a machine tool. The machine interface 26 may include a part of the housing of the tool holder 10. Likewise, further fastening means, such as screws, may belong to this machine interface 26. Further, in the present embodiment, the machine interface 26 includes a coolant port 28 disposed at the rear side of the tool holder 10.

The tool holder 10 further comprises a sensor receptacle 30, in which a sensor 32 is detachably mounted. As can be seen in particular from FIG. 2, the sensor receptacle 30 is configured as a pocket-shaped receptacle into which the sensor 32 can be inserted completely or at least almost completely. In the herein shown embodiment, the pocket-shaped sensor receptacle 30 surrounds the sensor 32 from five spatial sides. However, one of the six spatial sides is open in order to be able to remove the sensor 32 from the sensor receptacle 30, as schematically indicated in FIG. 2.

The sensor receptacle 30 is arranged on the tool holder 10 in such a way that, in the mounted state of the tool holder, the sensor inserted into the sensor receptacle 30 does not come into direct contact either with the tool 12 mounted on the tool holder 10 or with the machine tool to which the tool holder 10 is fastened. In other words, the sensor receptacle 30 is spaced from both the tool receptacle 14 and the machine interface 26.

The sensor 32 is preferably a force transducer. This force transducer is configured to measure the forces acting on the tool holder 10 resulting from the machining forces acting on the tool 12. In other words, the sensor 32 is used to measure the cutting or machining forces acting on the at least one cutting edge 22 during use of the tool 12. At least, the measurement signal generated by the sensor 32 is dependent on a force acting on the at least one cutting edge 22.

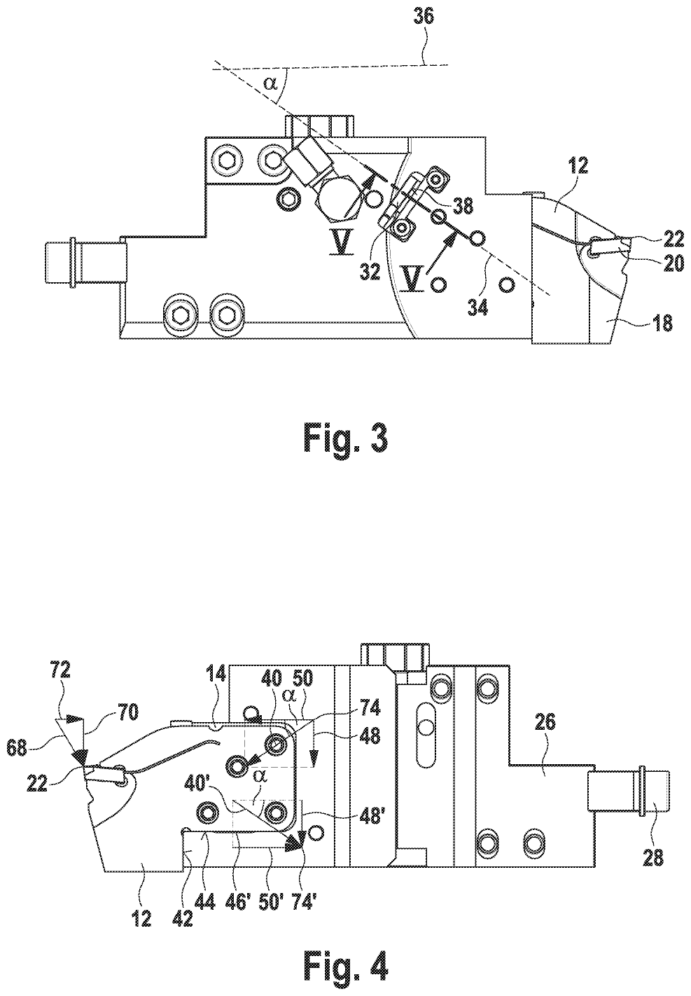

The sensor 32 is inclined in the tool holder 10. More specifically, a sensitive axis of the sensor 32, shown in FIG. 3 with a dashed line and indicated with reference numeral 34, is inclined with respect to the longitudinal direction or longitudinal axis 36 of the tool holder 10. The sensitive axis 34 is an axis along which the sensor 32 has its main sensitivity. This axis 34 is preferably perpendicular to a top or bottom surface 38 of the sensor 32.

The angle α, at which the sensitive axis 34 of the sensor 32 is inclined relative to the longitudinal axis 36 of the tool holder 10, preferably has a magnitude of 30°-60°. Thus, the angle α is preferably an acute angle.

The angle α is particularly preferably selected in such a way that the sensitive axis 34 of the sensor 32 coincides with the direction of a resultant force acting on the tool holder 10 during the machining process or is oriented at an angle of at most 10° relative to this direction. In particular, this is the direction of the resultant force at the location of the sensor 32. The direction of this resultant force is schematically indicated in FIG. 4 by means of an arrow with the reference numeral 40 or 40′.

During machining, a force acts on the cutting insert 20 or the cutting edge 22, which is schematically indicated with the arrow 68 in FIG. 4. This machining force 68 can be divided into a cutting force component 70 and a feed force component 72. In a three-dimensional view, the portion of the passive force perpendicular to it would also have to be considered, but this is omitted here for the sake of simplicity.

Due to the machining force 68, corresponding forces and moments are induced in the tool holder 10, whose amounts and directions differ from each other depending on the observation location in the tool holder 10. FIG. 4 shows schematically the force parallelograms for two possible positions 74, 74′, with the resulting forces 40, 40′ acting at these positions 74, 74′ respectively.

The resulting forces 40, 40′ each include a vertical force component 48, 48′ and a horizontal force component 50, 50′. The vertical force components 48, 48′ each result essentially from the cutting force component 70 of the machining force 68. The horizontal force components 50, 50′, on the other hand, result essentially from the feed force component 72 of the machining force 68 and from the moment-induced lever force at the respective position 74, 74′ of the sensor 32. The associated lever arms are the vertical and horizontal distances of the positions 74, 74′ from the cutting edge 22.

Hence, a tensile load results for position 74, whereas a compressive load results for position 74′. Thus, if the sensor 32 is arranged at the first position 74 in the tool holder 10, it is essentially subjected to a tensile load. On the other hand, if the sensor 32 is arranged at the second position 74′ in the tool holder 10, it is essentially subjected to a compressive load. Depending on the location, the alignment of the sensitive axis 34 of the sensor 32 is carried out as precisely as possible along the direction of the resulting force 40 or 40′.

It goes without saying that the positions 74, 74′ shown are possible positions of the sensor 32 in the force shunt. When the sensor 32 is arranged in the force shunt, only a part of the forces flows through the sensor 32. Therefore, the parallelograms schematically shown in FIG. 4 also represent only a part of the forces in the cutting plane of the tool holder 10, namely the part that flows through the sensor 32 at the respective position 74, 74′.

As can further be seen from FIG. 4, the tool 12 rests against two abutment surfaces 42, 44 in the tool receptacle 14 when the tool 12 is mounted on the tool holder 10. In the herein shown embodiment, the first abutment surface 42 extends in a vertical direction, while the second abutment surface 44 extends horizontally. Accordingly, the two abutment surfaces 42, 44 extend perpendicularly to each other. As can be seen in FIG. 4, the second abutment surface 44 is interrupted by a recess 46 in order to stabilize the support of the tool 12 or to be able to design it even more precisely.

Thus, depending on whether mainly tensile or compressive loads are to be measured with the sensor 32, two possible optimal positions (see positions 74, 74′) or alignments of the sensor 32 within the tool holder 10 result. One of the two optimal alignment possibilities is shown in FIG. 3, in which the sensitive axis 34 of the sensor 32 coincides with the direction 40 of the resulting force. The second optimal alignment possibility, which is not explicitly shown here, is the alignment of the sensitive axis 34 of the sensor 32 along the direction 40′ (cf. FIG. 4).

The more precisely the sensitive axis 34 is aligned with the direction 40 of the resulting force, the more accurate and stable measurements of the cutting forces acting on the at least one cutting edge 22 are possible. Since the second abutment surface 44 is in the present embodiment oriented parallel to the longitudinal axis 36 of the tool holder 10, the same angle α thus results not only between the sensitive axis 34 and the longitudinal axis 36, but also between the sensitive axis 34 and the second abutment surface. A corresponding opposite angle results between the sensitive axis 34 and the first abutment surface 42.

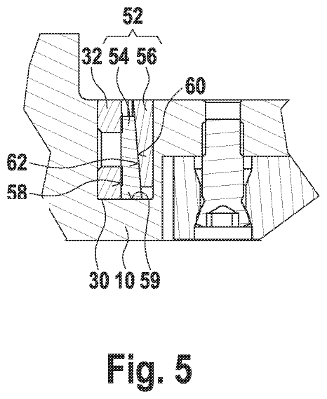

The sensor 32 is clamped in the tool holder 10 by means of a clamping device 52, which is shown in detail in FIG. 5. More precisely, the sensor 32 is clamped by means of this clamping device 52. The clamping device 52 comprises two wedge elements 54, 56. These two wedge elements 54, 56 are inserted into the sensor receptacle 30 in opposite directions to each other. The first wedge element 54 rests with its first side surface 58 against the sensor 32 and with its opposite second side surface 60 against a wedge surface 62 of the second wedge element 56. The first side surface 58 is preferably oriented parallel to the top surface of the sensor 32 against which it abuts. The second side surface 60 and the wedge surface 62 are preferably flush against each other and oriented at an acute angle relative to the first side surface 58 that abuts the sensor 32. The second wedge element 56 can preferably be displaced by means of two screws (not shown) (cf. FIGS. 1 and 2). In this way, the preload force with which the sensor 32 is preloaded in the sensor receptacle 30 can be precisely adjusted.

The first wedge element 54 rests on its end face against an abutment surface 59 provided inside the sensor receptacle 30. This abutment surface 59 serves as a support for the first wedge element 54. It supports the first wedge element 54 in particular during the insertion of the second wedge element 56 into the sensor receptacle 30 and thereby prevents a transmission of undesired shear forces from the first wedge element 54 to the sensor 32. Thus, the provided clamping device 52 enables the sensor 32 to be clamped within the sensor receptacle 30 without the sensor 32 experiencing undesired shear forces as a result.

It goes without saying that this type of supporting the first wedge element 54 may be accomplished in another manner without departing from the spirit and scope of the present disclosure.

However, a preload of the sensor 32 along its sensitive axis 34 is preferred. Such a preload is particularly necessary if not only compressive but also tensile loads are to be measured by means of the sensor 32. In case of a tensile load, the preload of the sensor 32 must be greater than the tensile force acting on the sensor 32 as a result of the machining process so that the sensor 32 always remains in a preloaded state.

The sensor 32 is connected via a cable 64, which is routed out of the sensor receptacle 30 to the outside through a cable duct 66 running inside the tool holder 10 (cf. FIG. 2). The cable 64 is thus safely protected from damage and connecting the sensor 32 can be done without any problems.

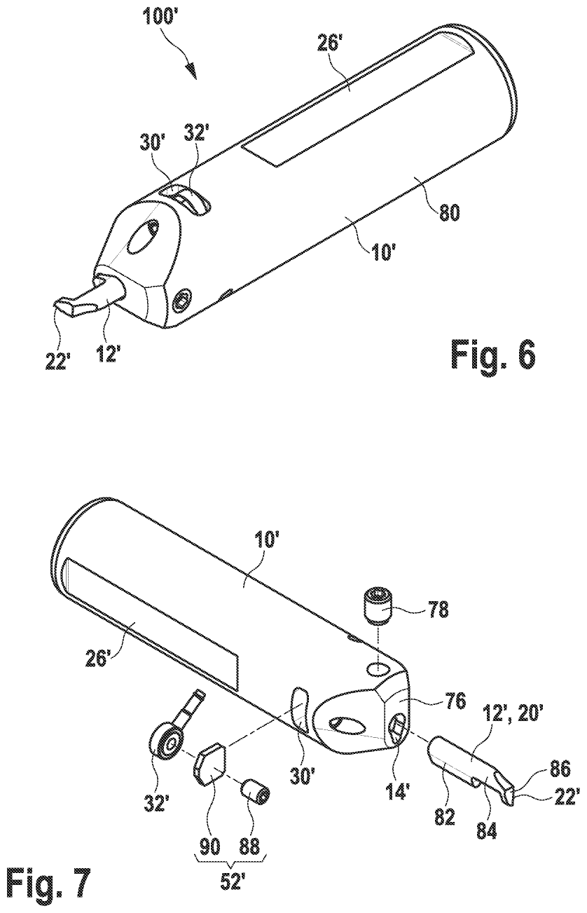

FIGS. 6-8 show a second embodiment of the tool system 100′. Identical or equivalent components are provided therein with the aforementioned reference signs including an additional apostrophe.

The tool system 100′ shown in FIGS. 6-8 is a cutting tool with an elongated tool holder 10′, at the front end 76 of which a pot-shaped tool receptacle 14′ is arranged. The tool 12′ is in this case a cutting insert 20′ which is releasably fastened in the tool receptacle 14′ by means of a fastening means 78. In this case, the fastening means 78 is configured as a clamping screw. However, it goes without saying that other possibilities for fastening the tool 12′ in the tool receptacle 14′ are also possible without leaving the spirit and scope of the present disclosure.

Here, the rear portion of a tool holder shank 80 serves as the machine interface 26′. This tool holder shank 80 may be partially flattened at one or more locations to facilitate attachment of the tool holder 10′ to a machine tool.

The cutting insert 20′ comprises a clamping section 82, a cantilever arm 84, and a cutting head 86 on which the at least one cutting edge 22′ is arranged. The cutting head 86 is arranged at the first end of the cantilever arm 84. The clamping section 82 is arranged at the opposite second end of the cantilever arm 84. The cantilever arm 84 has a smaller cross-section than the clamping section 82.

In the assembled state, the clamping section 82 of the tool 12′ is inserted into the tool receptacle 14′. In this embodiment, the clamping section 82 and the tool receptacle 14′ have a substantially teardrop-shaped cross-section.

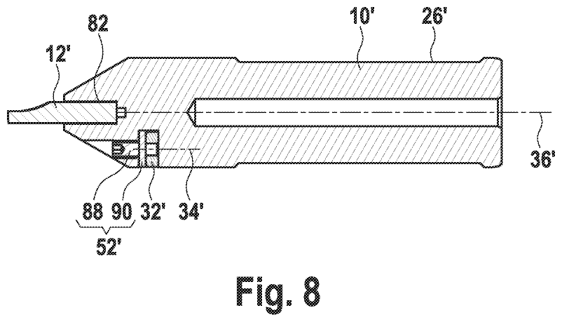

In this embodiment, the sensor 32′ is also removably inserted into a sensor receptacle 30′ that is spaced from both the tool receptacle 14′ and the machine interface 26′. Similarly, the position and orientation of the sensor 32′ is also in this case selected such that the sensor 32′ is exposed to the lowest possible shear forces and is positioned as parallel as possible to the force flow within the tool holder 10′. However, due to the slightly different force flow within the tool holder 10′, the sensitive axis 34′ is in this case aligned parallel or at least substantially parallel to the longitudinal axis 36′ of the tool holder 10′ (cf. FIG. 8).

In this case, the clamping device 52′ comprises a fastening screw 88 by means of which the sensor 32′ can be axially preloaded. In addition, a plate-shaped pressure piece 90 serves to distribute the force as evenly as possible and over the entire surface of the sensor 32′ and to avoid undesirable shear forces. The plate-shaped pressure piece 90 is arranged between the sensor 32′ and the fastening screw 88 and preferably lies flat against the sensor 32′. The mode of operation of the sensor 32′ otherwise corresponds essentially to the mode of operation as explained with respect to the first embodiment.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A tool holder, comprising:
a tool receptacle that is configured to releasably receive a tool having at least one cutting edge for machining a workpiece;
a machine interface that is configured to enable the tool holder to be fastened to a machine tool; and
a sensor receptacle in which a sensor is accommodated that is configured to generate a measurement signal that is dependent on a force acting on the tool holder, wherein the sensor receptacle is spaced apart from both the tool receptacle and the machine interface, so that the sensor is neither in direct contact with the tool nor in direct contact with the machine tool when the tool is accommodated in the tool receptacle and the tool holder is fastened to the machine tool.

2. The tool holder according to claim 1, wherein a sensitive axis of the sensor, along which the sensor has its main sensitivity, is oriented at an acute angle relative to a longitudinal axis of the tool holder.

3. The tool holder according to claim 2, wherein the sensitive axis coincides with a direction of a resultant force resulting from the force acting on the tool holder, or is oriented at an angle of at most 10° to said direction.

4. The tool holder according to claim 2, wherein the tool holder comprises a first abutment surface and a second abutment surface that extends transversely to the first abutment surface, and wherein the sensitive axis of the sensor is oriented at a first acute angle relative to the first abutment surface and at a second acute angle relative to the second abutment surface.

5. The tool holder according to claim 4, wherein the second contact surface is oriented parallel to the longitudinal axis of the tool holder.

6. The tool holder according to claim 1, wherein the sensor is arranged in a force shunt of the tool holder.

7. The tool holder according to claim 1, wherein the sensor receptacle comprises a pocket-shaped receptacle that encloses the sensor from at least four sides.

8. The tool holder according to claim 1, further comprising a clamping device that is configured to clamp the sensor in the sensor receptacle.

9. The tool holder according to claim 1, wherein the clamping device is configured to be at least partially detachable from the tool holder.

10. The tool holder according to claim 9, wherein the clamping device comprises a first wedge element and a second wedge element.

11. The tool holder according to claim 10, wherein the first wedge element abuts the sensor with a first side surface and abuts a wedge surface of the second wedge element with a second side surface that is arranged opposite to the first side surface, and wherein the second side surface and the wedge surface are oriented at an acute angle relative to the first side surface.

12. The tool holder according to claim 11, wherein the sensor receptacle comprises a support that is configured to support the first wedge element.

13. The tool holder according to claim 1, wherein a sensitive axis of the sensor, along which the sensor has its main sensitivity, is oriented parallel to a longitudinal axis of the tool holder.

14. The tool holder according to claim 1, wherein the tool receptacle is arranged at a face end of the tool holder and is configured as a pot-shaped recess in the tool holder.

15. The tool holder according to claim 1, wherein the sensor comprises a force transducer.

16. The tool holder according to claim 1, wherein the sensor comprises a cable that is routed out of the sensor receptacle through a cable duct extending inside the tool holder.

17. A tool system, comprising:
a tool having at least one cutting edge for machining the workpiece; and
a tool holder;
wherein the tool holder comprises:
a tool receptacle that is configured to releasably receive the tool;
a machine interface that is configured to enable the tool holder to be fastened to a machine tool; and
a sensor receptacle in which a sensor is accommodated that is configured to generate a measurement signal that is dependent on a force acting on the tool holder, wherein the sensor receptacle is spaced apart from both the tool receptacle and the machine interface, so that the sensor is neither in direct contact with the tool nor in direct contact with the machine tool when the tool is accommodated in the tool receptacle and the tool holder is fastened to the machine tool.

18. The tool system according to claim 17, wherein the tool comprises a tool cartridge having a cutting insert receptacle in which a cutting insert is arranged on which the at least one cutting edge is formed, and wherein the tool cartridge is detachably fastened to the tool holder in the tool receptacle by means of at least one fastening element.

19. The tool system according to claim 17, wherein the tool comprises a cutting insert on which the at least one cutting edge is formed, wherein the cutting insert comprises a clamping portion that is inserted into and releasably fastened in the tool receptacle of the tool holder.
